(19) United States
(12) Patent Application Publication
(10) Pub. No.: US 2008/0235410 A1
(43) Pub. Date: Sep. 25, 2008

(54) Usb-Sd Memory Device Having Dma Channels and Method of Storing Data in Usb-Sd Memory Device

(76) Inventor: Kwang-kyu Koh, Gyeonggi-do (KR)

Correspondence Address: CANTOR COLBURN, LLP, 20 Church Street, 22nd Floor, Hartford, CT, 06103, US

(21) Appl. No.: 11/915,079

(22) PCT Filed: May 19, 2006
(86) PCT No.: PCT/KR2006/001896

§ 371 Date: May 21, 2008

(30) Foreign Application Priority Data
May 20, 2005 (KR) 1020050042371

(51) Int. Cl. G06F 13/28

(52) U.S. Cl. 710/23

(57) ABSTRACT

Disclosed is a memory device having Universal Serial Bus (USB) interface and Secure Digital (SD) card interface, including: a plurality of flash memory units; a plurality of flash memory controllers each controlling reading and writing data on the flash memory unit; a Direct Memory Access (DMA) controller including a plurality of DMA channels each transmitting/receiving data to/from the flash memory unit in DMA mode; a Micom dividing a signal received from the USB interface and the SD card interface into data and an address and transmitting the data to the DMA controller; and an address decoder calculating positions of the received data to be written or read on the flash memory unit according to the address.

### TECHNICAL FIELD

The present invention relates to a memory device having Universal Serial Bus (hereinafter referred to as USB) and Secure Digital (hereinafter referred to as SD) card interface, and reading and writing data through a plurality of Direct Memory Access (hereinafter referred to as DMA) channels, and a method of storing the data in the memory device.

### BACKGROUND ART

With recent advances in data storage techniques, various kinds of portable memory devices are developed and used. Among the portable memory devices, a flash memory device having USB interface is widely used to store text data, music files, picture files, or moving image files, since the flash memory device has a large memory capacity, is convenient for a user to carry, and is easily connected to personal computers and other devices. The flash memory device is a kind of Electrically Erasable and Programmable ROM (EEPROM). It is roughly divided into a NOR type and a NAND type. A NOR-type flash memory device inputs and outputs data in byte units, and is mainly used as a memory device for codes since it is fast to read but markedly slow to write data. A NAND-type flash memory device inputs and outputs data in page units, and is mainly used as a large-capacity memory device since it is fast to write data and low in price per unit of area.

The flash memory device writes data in unit of block having a predetermined size and re-writable in a limited number of times. Accordingly, the flash memory device can be used for a long time if individual blocks constituting the flash memory device are equally used. In addition, a delete operation should be performed prior to writing data on the flash memory device, and is carried out in units greater than the write operation is carried out. Address conversion, which is carried out to equally use the blocks, is performed in a Flash Translation Layer (hereinafter referred to as FTL) that is middleware between a file system and a flash memory device. In FTL, a logical address generated by the file system in a write operation is converted into a physical address of an area on which a delete operation is already performed on the flash memory device.

An SD memory card is a kind of portable memory device including a flash memory device therein. The SD memory card is used as a data memory device of mobile phone, electronic book, Personal Digital Assistant (PDA), smart phone, digital camera, MP3 player, camcorder, personal computer or the like. The SD memory card has interface different from the USB interface to exchange data with a host.

Since a personal computer has both USB port and SD card reader as interface to peripheral devices, the personal computer can read and write data from a memory device having any interface. However, since most devices, such as digital camera, MP3 player, mobile phone, or camcorder, generally have any one of the USB interface and SD card interface, the devices having different interfaces cannot read and write data from each other. For instance, a digital camera having SD interface cannot transfer pictures to a mobile phone or MP 3 player having USB interface.

Korean Utility Model Publication No. 374,701 discloses an SD memory card having USB interface. The invention disclosed in the publication describes physical dimensions of the USB interface and SD card interface. However, it fails to describe signal lines and data flow in the USB and SD card interfaces, and an internal configuration for reading and writing data on a memory device. Further, SanDisk Corporation made a demonstration of an SD card that can be used on a USB port of a desktop or laptop in CES 2005.

However, the above-mentioned devices have a problem that it takes long time to read and write data from the flash memory device since the data is read and written through a single DMA channel.

### DISCLOSURE OF INVENTION

### Technical Solution

The present invention provides a USB-SD memory device that includes USB interface and SD card interface, and has a plurality of DMA channels to reduce the time required to access data and quickly read and write data.

### Advantageous Effects

According to the present invention, it is possible to quickly read and write data on a flash memory unit using USB interface, SD card interface, and DMA channels.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a USB-SC memory device according to an embodiment of the present invention;

FIG. 2 is a detailed block diagram of a USB-SD memory device;

FIG. 3 is a view for explaining a method of equally writing data on individual blocks constituting NAND flash memory units;

FIG. 4 is a flow chart of a method of writing data according to an embodiment of the present invention; and

FIG. 5 is a flow chart of a method of reading data according to an embodiment of the present invention.

### BEST MODE FOR CARRYING OUT THE INVENTION

According to an aspect of the present invention, there is provided a memory device having Universal Serial Bus (hereinafter referred to as USB) interface and Secure Digital (hereinafter referred to as SD) card interface, including: a plurality of flash memory units; a plurality of flash memory controllers each controlling reading and writing data on the flash memory unit; a Direct Memory Access (hereinafter referred to as DMA) controller including a plurality of DMA channels each transmitting/receiving data to/from the flash memory unit in DMA mode; a Micom dividing a signal received from the USB interface and the SD card interface into data and an address and transmitting the data to the DMA controller; and an address decoder calculating positions of the received data to be written or read on the flash memory unit according to the address.

According to another aspect of the present invention, there is provided a method of storing data through USB interface or SD card interface, including: (a) receiving a signal through the USB interface or SD card interface; (b) interpreting and dividing the signal into an address and data; (c) converting the address into an address of a flash memory unit on which the data is written, according to the address; and (d) transmitting the data to the converted address through two DMA channels in parallel mode and writing the data on the flash memory unit.

The operation (d) may further include, after receiving the data through the DMA channel, generate and add an error correction code to the data and write the data containing the error correction code on the flash memory unit.

### MODE FOR THE INVENTION

Exemplary embodiments in accordance with the present invention will now be described in detail with reference to the accompanying drawings.

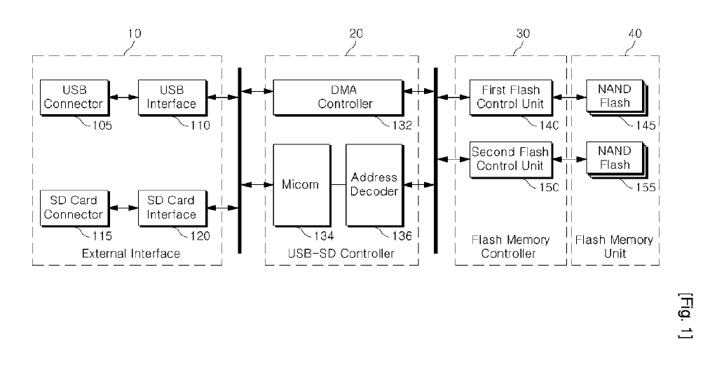

FIG. 1 is a block diagram of a Universal Serial Bus (hereinafter referred to as USB)-Secure Digital (hereinafter referred to as SD) memory device according to an embodiment of the present invention.

The USB-SD memory device includes an external interface 10, a USB-SD controller 20, a flash memory controller 30, and a flash memory unit 40. The external interface 10 includes a USB connector 105, a USB interface 110, an SD card connector 115, and an SD interface 120. The USB interface 110 converts serial data inputted through the USB connector 105 into USB commands and data that can be recognized by the USB-SD controller 20. The SD card interface 120 converts 4-bit data inputted through the SD card connector 115 into SD card commands and data that can be recognized by the USB-SD controller 20.

The USB-SD controller 20 includes a Direct Memory Access (hereinafter referred to as DMA) controller 132, a Micom 134, and an address decoder 136. The Micom 134 includes program RAM, data RAM, and Mask ROM. The Micom 134 interprets commands inputted through the SD interface and controls the DMA controller 132 and the address decoder 136 accordingly. The DAM controller 132 includes two DMA channels. For instance, when a first flash control unit 140 is operating, the DMA controller 132 controls such that data is written by means of a second flash control unit 150. Accordingly, since data is written in parallel mode according to the condition of flash memory unit 40, the data can be written in a shorter time. In addition, the DAM controller 132 uses two DMA channels when reading data. When data is written on a flash memory unit, the address decoder 136 performs an address decoding operation to equally use individual blocks constituting the flash memory unit. In addition, the address decoder 136 performs the same function as that of a flash translation layer (FTL). That is, the address decoder 136 converts a logical address generated by a file system into a physical address of an area on a flash memory unit on which a delete operation is already carried out.

The flash memory controller 30 includes the first and second flash control units 140 and 150. The flash memory unit 40 includes a plurality of NAND flash memory units. Since the flash memory controller 30 includes two flash control units, it can write data in parallel mode and thus write data in a shorter time. Further, the flash memory controller 30 generates and adds an error correction code (hereinafter referred to as ECC) to data and writes the data containing ECC on the flash memory unit 40. Even though the present embodiment describes that the flash memory unit 40 includes the NAND flash memory unit, the flash memory unit may include other nonvolatile memory units.

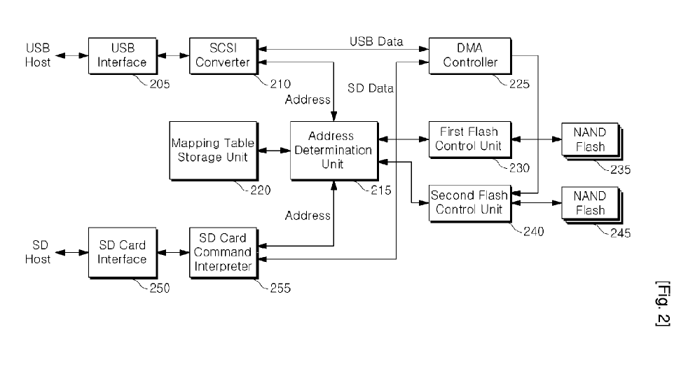

FIG. 2 is a detailed block diagram of a USB-SD memory device.

USB data is received through a USB interface 205 connected to a USB host, converted into an SCSI command by an SCSI converter 210, and divided into an address and data. The address is input to an address determination unit 215 and the divided data is input to a DMA controller 225. In addition, data is received through an SD card interface 250 connected to an SD host, and divided into an address and data by an SD card command interpreter 255. The address is input to an address determination unit 215 and the divided data is input to a DMA controller 225. The DMA controller 225 transmits data through DMA to a NAND flash memory unit that can be currently accessed according to the condition of flash memory controllers 230 and 240. The address determination unit 215 converts a logical address into a physical address on a NAND flash memory unit based on a conversion table stored in a mapping table storage unit 220, such that individual blocks constituting the NAND flash memory unit are equally used.

The first and second flash control units 230 and 240 receive data from the DMA controller 225, and write data on NAN-D flash memory units 235 and 245.

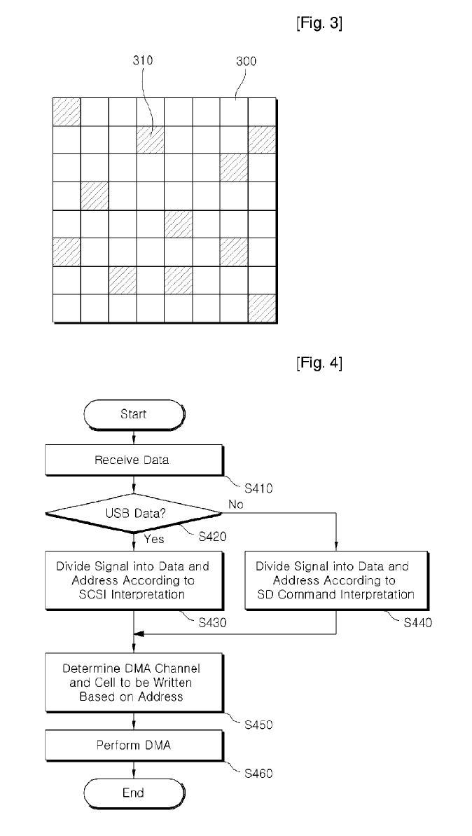

FIG. 3 is a view for explaining a method of equally writing, by the address determination unit 215, data on individual blocks constituting NAND flash memory units 235 and 245.

As described above, the NAND flash memory unit writes data in block units and is re-writable in a limited number of times. In addition, the NAND flash memory unit needs to delete a predetermined area prior to writing the data. FIG. 3 illustrates the NAND flash memory unit 300 divided into blocks each having a predetermined size. Once data is written on a block 310 up to a limited number or times, the NAND flash memory unit 300 can be no longer used. Accordingly, the address determination unit 215 assigns addresses of the flash memory unit according to a conversion table stored in the mapping table storage unit 220 so that data can be equally written on individual blocks.

FIG. 4 is a flow chart of a method of storing data according to an embodiment of the present invention.

A signal is received through USB interface or SD card interface (operation S410). It is determined whether the signal is received through the USB interface or SD card interface (operation S420). If the signal is received through the USB interface, the signal is divided into an address and data through SCSI conversion process. In this case, the address is transmitted to the address determination unit 215 and the data is transmitted to the DMA controller 225. (operation S430). If the signal is received through the SD card interface, the signal is divided into an address and data according to the above-mentioned SD card command interpretation. In this case, the address is transmitted to the address determination unit 215 and the data is transmitted to the DMA controller 225. (operation S440). A DMA channel is determined according to its condition, and a write address of the flash memory unit is determined (operation S450). Next, DMA operation is performed (operation S460).

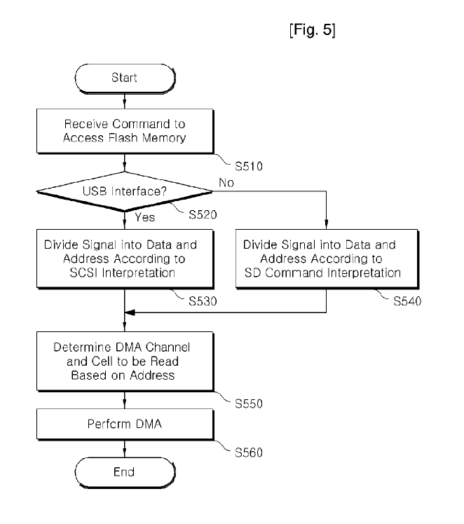

FIG. 5 is a flow chart of a method of reading data according to an embodiment of the present invention.

A signal stored in the flash memory unit is read through the USB interface or SD card interface using two DMA channels to increase a reading speed. A command to access the flash memory unit is received through the USB interface or SD card interface (operation S510). It is determined whether the flash memory unit is accessed through the USB interface or SD card interface (operation S520). If the flash memory unit is accessed through the USB interface, a signal is subjected to SCSI conversion process and divided into data and an address. In this case, the address is transmitted to the address determination unit 215 and the data is transmitted to the DMA controller 225 (operation S530). If the flash memory unit is accessed through the SD card interface, a signal is divided into an address and data according to the above-mentioned SD card command interpretation. In this case, the address is transmitted to the address determination unit 215 and the data is transmitted to the DMA controller 225 (operation S540). The DMA channel is determined according to its condition, and a read address of the flash memory unit is determined (operation S550). Next, DMA is performed (operation S560).

The above-mentioned method of storing and reading data may be written with computer programs. Codes and code segments constituting the programs can be easily deduced by computer programmers skilled in the art. In addition, the programs are stored in computer readable media, read and executed by computers, thereby implementing the method of storing and reading data. Examples of the computer readable media include magnetic recording media, optical recording media, and carrier wave media.

While the present invention has been described with reference to exemplary embodiments thereof, it will be understood by those skilled in the art that various changes in form and details may be made therein without departing from the scope of the present invention as defined by the following claims.

### INDUSTRIAL APPLICABILITY

The present invention can be applied to a memory device having USB interface and SD card interface and reading and writing data through a plurality of DMA channels.

1. A memory device including Universal Serial Bus (hereinafter referred to as USB) interface and Secure Digital (hereinafter referred to as SD) card interface, comprising:
a plurality of flash memory units;
a plurality of flash memory controllers each controlling reading and writing data on the flash memory unit;
a Direct Memory Access (hereinafter referred to as DMA) controller including a plurality of DMA channels each transmitting/receiving data to/from the flash memory unit in DMA mode;
a Micom dividing a signal received from the USB interface and the SD card interface into data and an address and transmitting the data to the DMA controller; and
an address decoder calculating positions of the received data to be written and read on the flash memory unit according to the address.

2. The memory device of claim 1, wherein the flash memory controller generates and adds an error correction code to the data and writes the data containing the error correction code on the flash memory unit.

3. The memory device of claim 1, further including a conversion table storing conversion information concerning conversion of the address into a physical address of the flash memory unit so that individual blocks constituting the flash memory unit can be equally used.

4. The memory device of claim 3, wherein the address decoder converts a physical address of the data to be suited to an address system of the flash memory unit according to the conversion table stored in a mapping table storage unit.

5. A method of storing data through USB interface or SD card interface, comprising:
(a) receiving a signal through the USB interface or SD card interface;
(b) interpreting and dividing the signal into an address and data;
(c) converting the address into an address of a flash memory unit on which the data is written, according to the address; and
(d) transmitting the data to the converted address through two DMA channels in parallel mode and writing the data on the flash memory unit.

6. The method of claim 5, wherein the operation (d) further includes, after receiving the data through the DMA channel, generating and adding an error correction code to the data and writing the data containing the error correction code on the flash memory unit.

7. The method of claim 5, wherein the operation (c) refers to a conversion table storing conversion information concerning conversion of the address into a physical address of the flash memory unit so that individual blocks constituting the flash memory unit can be equally used, and converts a physical address of the data to be suited to an address system of the flash memory unit.

8. A computer readable medium recording a program for executing on a computer a method of storing data through USB interface or SD card interface, the method including:
(a) receiving a signal through the USB interface or SD card interface;
(b) interpreting and dividing the signal into an address and data;
(c) converting the address into an address of a flash memory unit on which the data is written, according to the address; and
(d) transmitting the data to the converted address through two DMA channels in parallel mode and writing the data on the flash memory unit.

9. The computer readable medium of claim 8, wherein the computer readable medium is a flash memory device including USB interface and SD card interface.

10. The computer readable medium of claim 8, wherein the operation (d) further includes, after receiving the data through the DMA channel, generating and adding an error correction code to the data and writing the data containing the error correction code on the flash memory unit.

11. The computer readable medium of claim 8, wherein the operation (c) refers to a conversion table storing conversion information concerning conversion of the address into a physical address of the flash memory unit so that individual blocks constituting the flash memory unit can be equally used, and converts a physical address of the data to be suited to an address system of the flash memory unit.

12. The computer readable medium of claim 10, wherein the computer readable medium is a flash memory device including USB interface and SD card interface.

13. The computer readable medium of claim 11, wherein the computer readable medium is a flash memory device including USB interface and SD card interface.
